(19) United States
(12) Patent Application Publication
(10) Pub. No.: US 2022/0247074 A1
(43) Pub. Date: Aug. 4, 2022

(54) ANTENNA ARRAY PATTERN ENHANCEMENT USING APERTURE TUNING TECHNIQUE

(71) Applicant: Qorvo US, Inc., Greensboro, NC (US)

(72) Inventors: Abolghasem Zamanifekri, Den Bosch (NL); Roberto Gaddi, Rosmalen (NL); Paul Anthony Tornatta, San Jose, CA (US)

(21) Appl. No.: 17/612,777

(22) PCT Filed: May 20, 2020
(86) PCT No.: PCT/US2020/033765

§ 371 Date: Nov. 19, 2021

Related U.S. Application Data
(60) Provisional application No. 62/850,219, filed on May 20, 2019.

(51) Int. Cl. H01Q 3/42; H01Q 3/38

(52) U.S. Cl. CPC H01Q 3/42; H04B 7/0413; H01Q 3/38

(57) ABSTRACT

An aperture antenna tuning technique is used in an antenna array to improve the performance and, therefore, enhance the overall system efficiency for wireless devices. The aperture tuning occurs by using an aperture tuner to change the phase response of the antenna array radiation pattern. The aperture tuning improves the signal to noise ratio (SNR) by enhancing an array radiation pattern in a desired direction.

### FIELD OF THE DISCLOSURE

Embodiments of the present disclosure generally relate to devices containing wireless communication circuitry.

### BACKGROUND

Since the very first mobile phone call made in 1973, there have been tremendous efforts and therefore advancements in the cellular and wireless world to deliver higher quality of service (QoS) and quality of experience (QoE) to a wide variety of end users. Providing high speed data rate in a very congested frequency spectrum is an important prerequisite to satisfy expected QoE in 5G networks. For example, 5G peak downlink throughput is expected to be around 10 Gbps in the dense urban environments.

Satisfying 5G network requirements imposes challenging design tasks in both the base station (BS) side and the user equipment (UE) side. Implementing wireless designs at the UE side is much more difficult than at the BS side due to the large limitations on energy efficiency, battery life, and available hardware dimensions.

Two important enabling technologies included in 5G are high order (i.e., massive) Multiple Input Multiple Output (MIMO) and the use of phased array antenna technology. The many restrictions due to the physical design of a mobile handset make the implementation of either MIMO or phased array antenna technology very challenging. For both MIMO and phased array antenna technology, antenna design and optimization plays an important role in any successful design procedure. A further challenge is to integrate antenna systems that support multi bands and multi standards for different communication protocols (e.g., Cellular, WIFI, Bluetooth, near-field communication, etc.) that occupy a very wide range of frequencies (e.g., 600 MHz to 6 GHz and further to mmWave frequencies).

Current solutions to 5G antenna design requirements are based on implementing conventional phased array as beamforming (BF) modules capable of increasing signal-to-noise ratio (SNR) and reducing channel interference in a data stream. In phased array antenna technology, a phase shifter in front of each antenna module controls the phase of each antenna radiation pattern. Having control over amplitude and phase of each antenna makes it possible for an antenna designer to scan the beam towards the desired direction (thus improving SNR) or control the null location in any targeted point in space (thus reducing channel interference). For small devices (e.g., small cells, CPE's, routers, and mobile phones), there is not enough space to support a large number of antenna elements for a phased array. A more common configuration may contain only four elements in the array. With a small array, the losses in the phase shifter network will overcome the benefit of the array implementation. For this reason, an alternative method of controlling the array element relative phases is needed.

In terms of MIMO implementation, the current state of the art has not yet fully demonstrated the capability in term of dimensions of UPLINK and DOWNLINK which are compatible to a UE form factor.

Therefore, there is a need in the art for effectively tuning an antenna.

### SUMMARY

The present disclosure generally relates to an aperture antenna tuning technique that is used in an antenna array to improve the performance and, therefore, enhance the overall system efficiency for wireless devices. The aperture tuning occurs by using an aperture tuner on each antenna of the array, with the purpose of changing the phase response of the antenna radiation pattern. The aperture tuning improves the SNR by enhancing the overall array radiation pattern in a desired direction.

In one embodiment, an electronic device, comprises an antenna array having a plurality of antennas; and a plurality of antenna aperture tuning elements coupled to all antennas in the array.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic illustration of a device, in this example a cellular telephone, with a DVC (digital variable capacitor) and antenna.

FIG. 2 is a schematic illustration of a DVC as one of many possible instantiations of a variable reactance, according to one embodiment.

FIGS. 3A-3C are schematic cross-sectional illustrations of a microelectromechanical (MEMS) DVC device that can be utilized as variable reactance according to one embodiment.

FIG. 4 is a schematic view of one implementation of aperture tuned phased array.

FIG. 5A shows a schematic diagram of how the phase of the antenna radiation pattern and the corresponding reflection coefficient change versus tuner setting (connected to the aperture).

FIG. 5B shows a single antenna radiation pattern and corresponding reflection coefficient (return loss) for four alternative control states.

FIG. 6A is a schematic view of proposed concept.

FIG. 6B is a radiation pattern counterpart for the array of FIG. 6A.

FIG. 7 shows the antenna element which is used in one implementation of an antenna array.

FIG. 8 illustrates the realized gain of 2×2 antenna array in phi=0 plane in spherical coordinate for one implementation.

FIG. 9 shows a comparison of probability distribution of best achievable realized gain of implementation of lossy aperture tuned antenna versus phase shifter implementation with 3 dB insertion loss.

FIG. 10 shows a correlation coefficient of one pair of antenna from the 2×2 array versus control states of all four connected tuners for one implementation.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The present disclosure generally relates to an aperture antenna tuning technique that is used in an antenna array to improve the performance and, therefore, enhance the overall system efficiency for wireless devices. The aperture tuning occurs by using an aperture tuner to change the phase response of the antenna array radiation pattern. The aperture tuning improves the SNR by enhancing an array radiation pattern in a desired direction.

This disclosure uses aperture tuned antennas as the elements in the antenna array. By changing the frequency tuning of the elements in the antenna array, an effective phase shift between elements can be realized. The phase shift happens without introducing additional loss in the RF path of each antenna. For example, the insertion loss of a MEMS based aperture tuner is around 0.2 dB. However, the insertion loss of a phase shifter is between 2 and 5 dB depending on the bandwidth being covered. Therefore, an aperture tuner solution has more than 10× lower loss than the phase shifter implementation.

The device disclosed herein can be either part of the infrastructure of a wireless communications network like a base station, small cell, or customer premises equipment (CPE) or designed to be used by the end user such as a computer, tablet or mobile phone. The device containing the wireless circuitry can support advanced communications protocols that require multiple antennas and/or very high signal to noise ratio such as WiFi, LTE, and 5G. In the case of advanced communication systems, like 5G, the communication device will require an architecture for antenna tuning that can improve the realized array gain (system efficiency) in arbitrary directions in space and compensate changes that occur when the device is held in the hand or adjacent of the head.

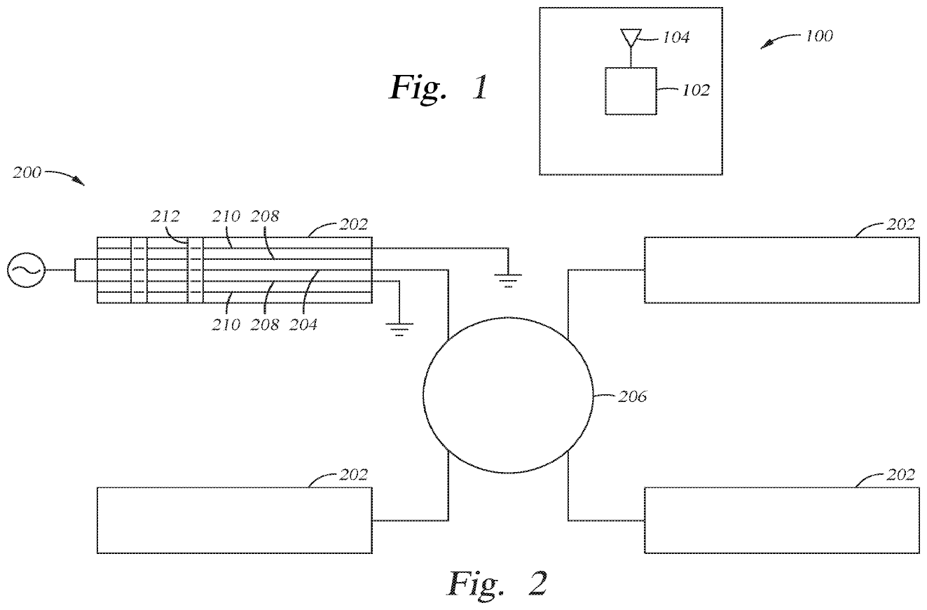

FIG. 1 is a schematic illustration of an electronic device 100, in this example a cellular telephone, with a digital variable capacitor (DVC) 102 and antenna 104. FIG. 2 is a schematic illustration of a Micro Electro Mechanical System (MEMS) based DVC 200 that may be utilized to tune an antenna array according to one embodiment. The MEMS DVC includes a plurality of cavities 202 that each have an RF electrode 204 that is coupled to a common RF bump 206. Each cavity 202 has one or more pull-in or pull-down electrodes 208 and one or more ground electrodes 210. A switching element 212 moves from a position far away from the RF electrode 204 and a position close to the RF electrode 204 to change the capacitance in the MEMS DVC 200. The MEMS DVC 200 has numerous switching elements 212 and therefore has a large variable capacitance range that can be applied/removed from an antenna aperture in order to maintain a constant resonant frequency and compensate for changes in the electrical characteristics of an antenna that is under the influence of environmental changes or head/hand effect. The MEMS DVC 200 is, in essence, a collection of multiple individually controlled MEMS elements.

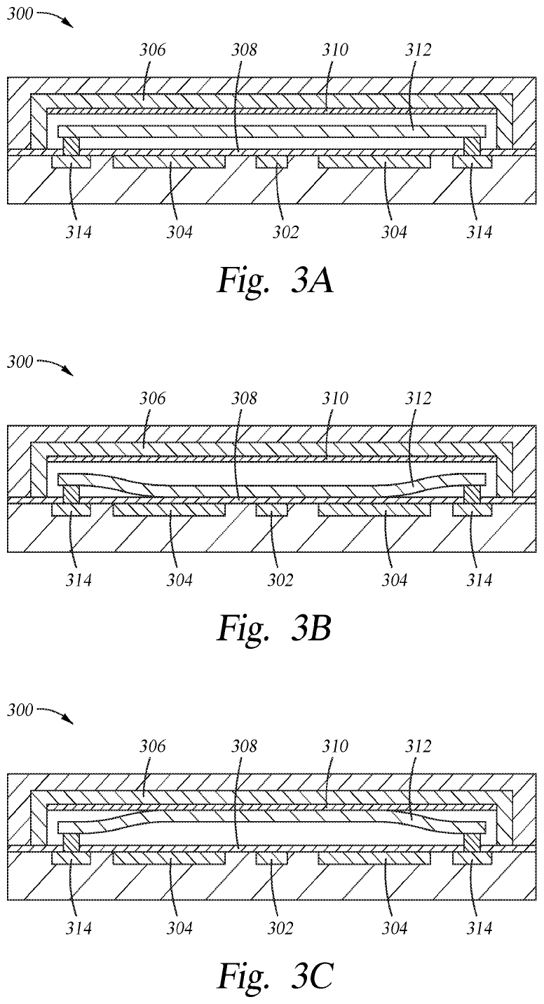

FIGS. 3A-3C are schematic cross-sectional illustrations of a single MEMS element 300 that can create the plurality of switching elements 212 in the plurality of cavities 202 in MEMS DVC 200, according to one embodiment. The MEMS element 300 includes an RF electrode 302, one or more pull-down electrodes 304, one or more pull-up electrodes 306, a first dielectric layer 308 overlying the RF electrode 302 and the one or more pull-down electrodes 304, a second dielectric layer 310 overlying the one or more pull-up electrodes 306, and a switching element 312 that is movable between the first dielectric layer 308 and the second dielectric layer 310. The switching element 312 is coupled to grounding electrodes 314. As shown in FIG. 3B, the MEMS element 300 is in the maximum capacitance position when the switching device 312 is closest to the RF electrode 302. As shown in FIG. 3C, the MEMS element 300 is in the minimum capacitance position when the switching device 312 is furthest away from the RF electrode 302. Thus MEMS element 300 creates a variable capacitor with two different capacitance stages, and integrating a plurality of such MEMS element 300 into a single MEMS DVC 200 is able to create a DVC with great granularity and capacitance range to effect the reactive aperture tuning that is required to maintain a constant resonant frequency, and compensate for changes in the electrical characteristics of an antenna that is under the influence of environmental changes or head/hand effect.

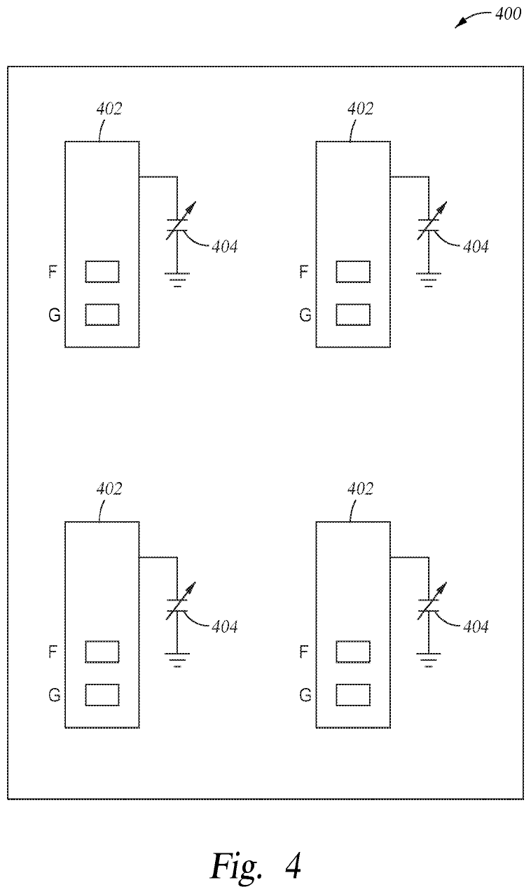

FIG. 4 is a schematic view of one proposed approach in a 2×2 antenna array 400 for one implementation. In the antenna array 400, there are four antenna systems shown, with each antenna comprising an antenna 402 and an element 404, such as an aperture tuning element. Each antenna 402 (oftentimes referred to as an antenna aperture) is connected to an element 404, such as a capacitive tuner. The element 404 loads the antenna 402 capacitively, thus affecting both the frequency response and radiated fields of the each antenna 402 of the array 400. As shown in FIG. 4, the element 404 may include one or more capacitors 408, one or more variable capacitors 410, one or more inductors 412, and combinations thereof. Thus, it is to be understood that the element 404 may include a plurality of capacitors 408, a plurality of variable capacitors 410, a plurality of inductors 412, and combinations thereof. Furthermore, switches 406 are shown to selectively engage the one or more capacitors 408, the one or more variable capacitors 410, and the one or more inductors 412.

It is to be understood that while a 2×2 antenna array is exemplified in FIG. 4, the disclosure is not to be limited to a 2×2 antenna array. Rather, the disclosure is applicable to any number of antenna systems in an antenna array.

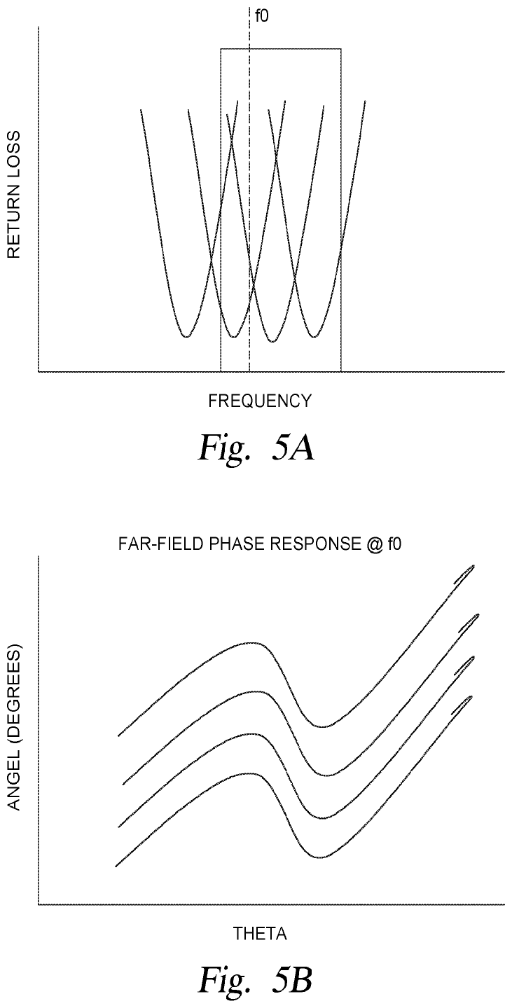

FIG. 5A shows a schematic diagram of how the return loss of the antenna 402 changes versus tuner setting (connected to the aperture). For FIG. 5B, a radiation pattern of a single antenna 402 is shown in terms of phase of the radiated field for four alternative control states.

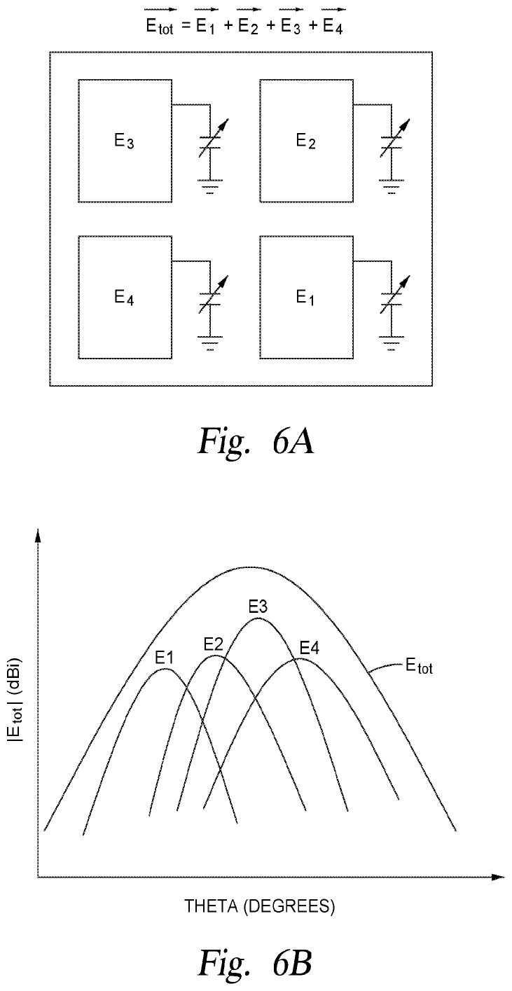

As illustrated in FIG. 6A, the superposition of four individual radiation patterns generates enhanced total radiation pattern of the array 400 in this application. Phasor of each antenna (E1,E2,E3,E4) can be changed through the tuner connected to each antenna aperture 402 in order to adjust the total array radiation pattern desirably.

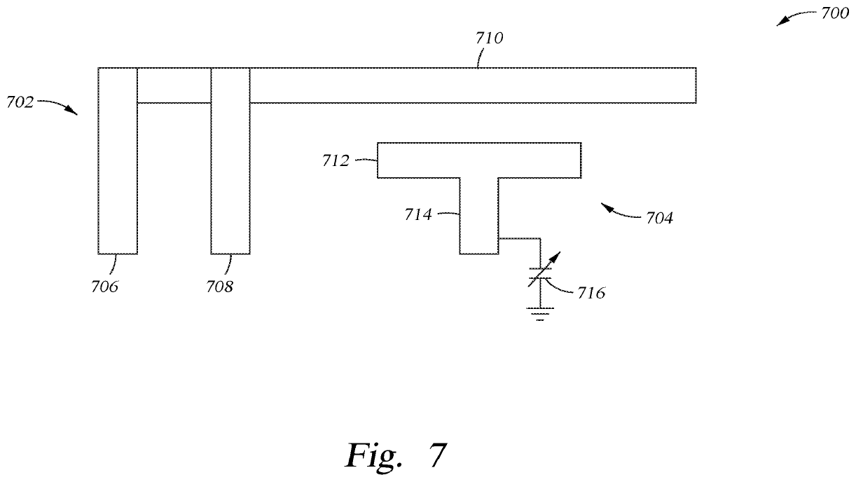

FIG. 7 shows the antenna system 700 which is used in one implementation of 2×2 array. The antenna system 700 includes an antenna 702 (which may be the antenna 402 of FIG. 4) and an aperture tuning element 704 (which may be the element 404 of FIG. 4). The antenna 702 includes a first radiator portion 710, one RF input 706 and one grounding leg 708. It is to be understood that more than one RF inputs could be present, while the grounding leg could also be absent or there could be more than one grounding legs. The first radiator portion 710 may comprise a metal plate. The aperture tuning element 704 includes a second conducting portion 712. The second conducting portion 712 may comprise a metal plate. A post portion 714 is also shown though the post portion 714 may be eliminated. The tuning element 704 also includes a shunt tuner 716. The shunt tuner 716 is coupled to the second conducting portion 712 on one side to capacitively couple electric field to the antenna aperture. The other side of the shunt tuner 716 is connected to the ground plane of the device. The beam and conducting portions 710, 712 are parallel to each other. FIG. 7 shows one possible implementation of the antenna element. The important feature of this antenna element is the tuner is coupled to the antenna aperture rather than to the RF input feed line. The tuner element is not in the direct feed path between the antenna and the rest of the radio system.

One might use the definition of antenna realized gain as a relevant figure-of-merit to evaluate the achieved results. Realized gain of an antenna is defined as below:

$$Realized gain = \frac{4 π U}{{P}_{i n c}}$$

Where U is radiation intensity of the antenna (expressed as Watts/sr) and P_{inc} is an incident power to the antenna (expressed in Watts). P_{inc} is used instead of total radiated power in order to take into account also mismatch loss and antenna loss.

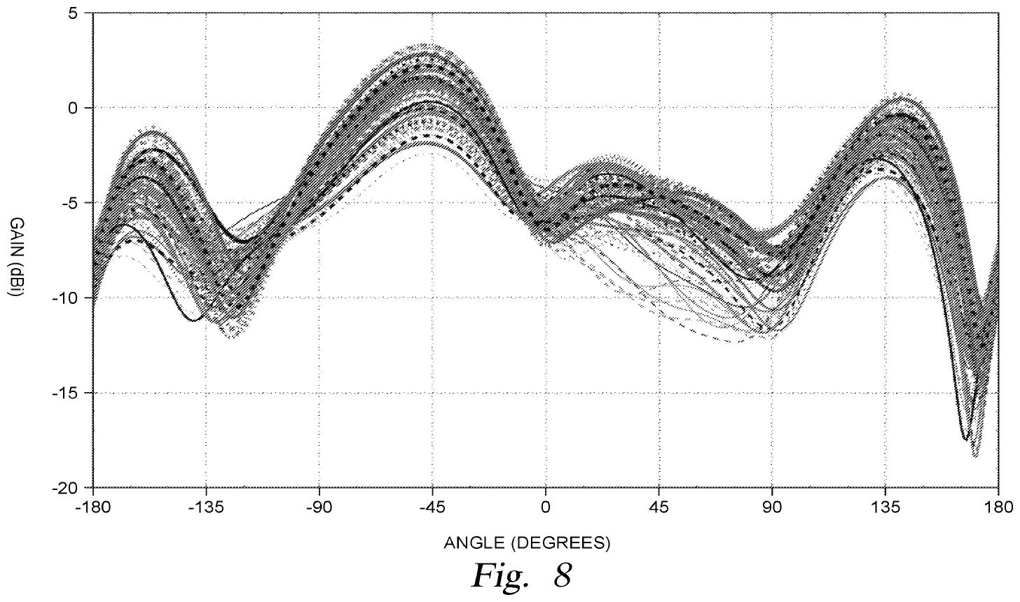

FIG. 8 shows the realized gain of 2×2 array in phi=0 plane in spherical coordinates for one implementation, calculated for 81 different combinations of states of the 4 individual elements 404. One might notice that in each value of the x-axis (space direction Theta) the superimposed radiation pattern has different value depend on the 4 states of the 4 connected tuners.

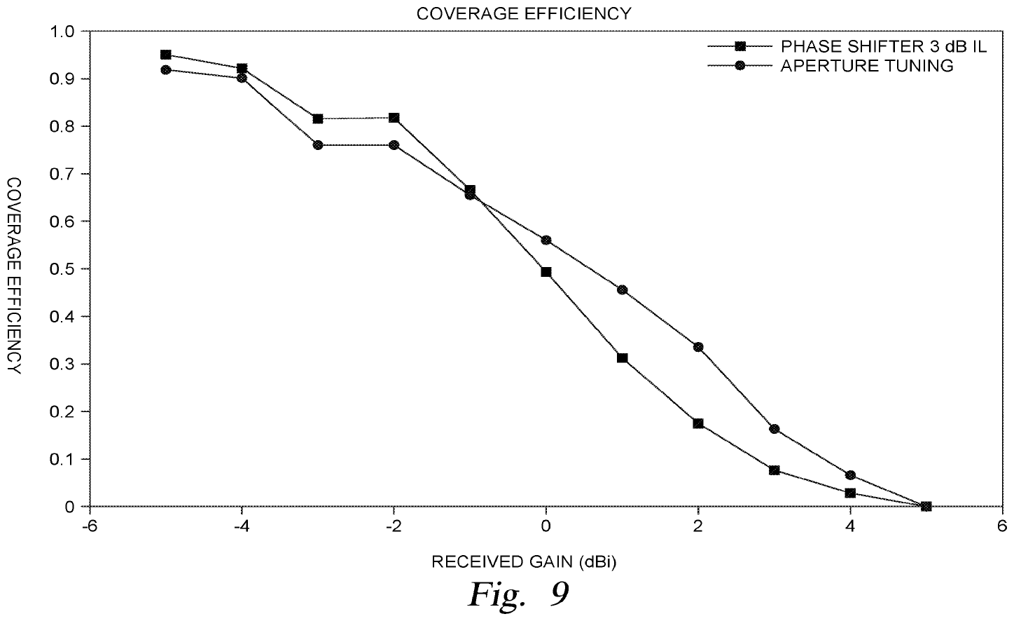

More interesting is to evaluate the antenna gain in all directions in 3D space instead of along a single cut-plane. This is done by analyzing the radiation pattern every 10 degrees in both Phi and Theta to cover the entire sphere with a total of 648 space directions. FIG. 9 shows a coverage efficiency plot for this embodiment. Each data point quantifies the maximum realized gain across all 81 possible settings of the four tuners which are connected to the four antenna elements.

From a system design point of view, it makes sense to compare these results to a non-tuned antenna to get more understanding of potential advantages. This comparison is summarized in Table 1. By adopting the aperture tuned approach, the realized gain of the antenna system is improved on average by a value close to 1 dB, with a best case of more than 5 dB. 100% of the analyzed space directions show an improvement, as indicated by the last row in the table.

TABLE 1
Results of present disclosure in comparison
with non-tuned antenna.

| Parameter | Value |
|---|---|
| Average enhancement | 1.19 dB |
| Minimum enhancement | −0.52 dB |
| Maximum enhancement | 6.54 dB |
| Percentage of enhancement | 96 |

It must be stressed how the beam forming performance achieved using aperture tuned antenna elements surpasses the traditional approach of using phase shifters since these add unavoidable and considerable power losses (several dB typical, depending on frequency of interest).

FIG. 9 [replaced] shows the comparison of Coverage efficiencies between aperture tuned antenna array implementation (including losses) versus traditional implementation using phase shifters with 3 dB insertion loss, which is a typical value for state-of-the-art phase shifters. The proposed technique in the present disclosure improves the realized gain of the antenna array in almost 80 percent of all the simulated directions in space.

The 2×2 proposed array in FIG. 4 can also be used as MIMO array. Avoiding the use of phase shifters for beam forming brings immediate advantage also when antennas are used independently in a MIMO configuration. Furthermore, there are more advantages in the use of aperture tuned antenna elements for MIMO applications.

The well-known figure of merit (FOM) for MIMO antennas is called correlation coefficient (CC). This quantity varies from 0 to 1 and it is an indication of how the radiation patterns of any pair of antennas are uncorrelated: 0 means no correlation, 1 means perfect correlation. FIG. 9 shows the correlation coefficient of a pair of antennas from the 2×2 array versus the control states of the four connected tuners. From an antenna designer point of view, having control over CC by changing tuner control state adds one desired degree of freedom to antenna design space.

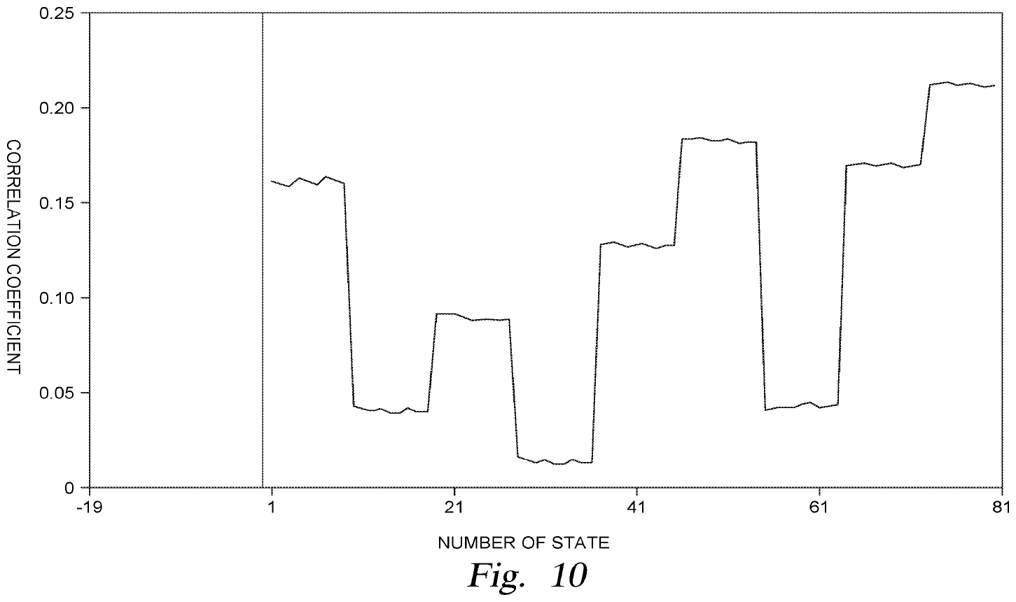

FIG. 10 shows a correlation coefficient of one pair of antenna from the 2×2 array versus control states of all four connected tuners for one implementation of presented disclosure in FIG. 4.

In one embodiment, an electronic device comprises: an antenna array having a plurality of antennas; and a plurality of aperture tuning elements coupled to the antennas. The number of aperture tuning elements of the plurality of aperture tuning elements is equal to the number of antennas of the plurality of antennas. At least one aperture tuning element is a digital variable capacitor. The digital variable capacitor includes at least one MEMS element. At least one aperture tuning element of the plurality of aperture tuning elements is a capacitive tuner. In one embodiment, the antenna array is a 2×2 array. At least one antenna of the plurality of antennas includes a first radiator portion, and at least one RF input. At least one antenna of the plurality of antennas includes at least one RF input. At least one aperture tuning element of the plurality of aperture tuning elements includes a second conductive portion, wherein the second conductive portion is parallel to the first radiator portion. At least one aperture tuning element includes a capacitive tuner. At least one aperture tuning element is a digital variable capacitor. The digital variable capacitor includes at least one MEMS device. The electronic device utilizes beamforming capability. The electronic device utilizes MIMO capability.

By having a tuning element at each antenna of an antenna array, the following items are achieved. Improving SNR of antenna system by enhancement of array radiation pattern in desired direction. Reducing channel interference by adjustment of array radiation pattern. Large reduction in required physical dimensions compared to phase shifter implementation. Improving MIMO capability by adjusting aperture tuner control state (decreasing correlation coefficient). Avoiding large insertion loss of phase shifter in either of beamforming application or MIMO application. Having the capability of compensation of head and hand effect by changing control states of each antenna element. Huge reduction cost in array implementation.

Those skilled in the art will recognize improvements and modifications to the preferred embodiments of the present disclosure. All such improvements and modifications are considered within the scope of the concepts disclosed herein and the claims that follow.

1. An electronic device, comprising:
an antenna array having a plurality of antennas; and
at least one element coupled to at least one antenna of the plurality of antennas that can change resonant frequency and thereby relative phase between antennas of the plurality of antennas, wherein the at least one element comprises:
at least one capacitor;
at least one inductor; and
at least one switch configured to engage one or more of the at least one capacitor and the at least one inductor.

2. The electronic device of claim 1, wherein the at least one element is a network capable of synthesizing an arbitrary and tunable impedance.

3. The electronic device of claim 1, further comprising an impedance matcher coupled to the at least one element that creates a phase shift.

4. The electronic device of claim 1, wherein the at least one element is selected from a group consisting of: a switch with one or more inductors coupled thereto, a switch with one or more capacitors coupled thereto, and combinations thereof.

5. The electronic device of claim 1, wherein a number of elements of the at least one element is equal to a number of antennas of the plurality of antennas.

6. The electronic device of claim 5, wherein the at least one element is a digital variable capacitor.

7. The electronic device of claim 6, wherein the digital variable capacitor includes at least one microelectromechanical element.

8. The electronic device of claim 1, wherein the antenna array is a 2×2 array.

9. The electronic device of claim 1, wherein the at least one antenna of the plurality of antennas includes a first beam portion, and at least one RF input.

10. The electronic device of claim 1, wherein the at least one antenna of the plurality of antennas includes at least one RF input.

11. The electronic device of claim 9, wherein the at least one element includes a second beam portion, wherein the second beam portion is parallel to and in vicinity of the first beam portion.

12. The electronic device of claim 11, wherein the at least one element includes a capacitive tuner.

13. The electronic device of claim 11, wherein the at least one element is a digital variable capacitor.

14. The electronic device of claim 13, wherein the digital variable capacitor includes at least one microelectromechanical device.

15. The electronic device of claim 1, wherein the electronic device utilizes multiple-input multiple-output (MIMO) capability.
